(19) United States
(12) Patent Application Publication
(10) Pub. No.: US 2006/0224515 A1
(43) Pub. Date: Oct. 5, 2006

(54) Method of purchasing digital music, concerts, movies, television shows

(76) Inventors: Mark S. Lemon, Surrey, British Columbia (CA); James P. Robinson, Langley, British Columbia (CA)

Correspondence Address: VERMETTE & CO., BOX 40, GRANVILLE SQUARE, SUITE 230 - 200 GRANVILLE STREET, VANCOUVER, BC, V6C 1S4, CA

(21) Appl. No.: 10/907,493

(22) Filed: Apr. 4, 2005

(51) Int. Cl. G06F 17/60

(52) U.S. Cl. 705/51

(57) ABSTRACT

A method of distributing digital entertainment works at least partly over a global computer network, which includes providing a card containing a code and information as to a digital entertainment work associated with each card, distributing the card to a purchaser, providing a website having a transfer area, the website being accessible over the Internet by the purchaser utilizing a user computer. In response to the purchaser requesting access to a transfer area of the website and inputting the code and prompted information about the digital entertainment work, verifying an authenticity of the card. The purchaser is then provided access to the transfer area for the purpose of transferring the digital entertainment work. Finally the purchaser is permitted to transfer the digital entertainment work onto the user computer.

### FIELD

The present invention relates to a method of purchasing digital entertainment works, namely, digital music, movies, television shows, and concerts over a global computer network such as the Internet.

### BACKGROUND

Before being enjoined by the 9^{th} District Court, Napster experienced explosive growth in its business of facilitating others to transfer copyrighted digital music. While peer-to-peer file sharing has been held to be legal in both Canada and the U.S., Canada is presently moving to make such activity an infringement of copyright. The U.S. appears poised to do the same and it appears that other countries may soon follow. Consequently, the door may soon close on those who obtain their music and movies free over the Internet. It is possible to obtain digital music over the Internet either through purchase with a credit card. However, teenagers and young adults, one of the biggest markets for such content, rarely have credit cards and so are restricted to buying such content from music stores. Music stores offer CD's having a group of songs and are priced well above the cost of a single song. Consequently, anyone wishing only one song must buy an entire album of songs.

Prepaid cards for purchasing digital music and video content over the Internet have been disclosed. An identity number is provided for each card which together with other information, allows the purchaser to set his/her own prepaid limit. However, the card must be used with a card reader/writer so that the available balance can be changed after each purchase and a personal identifier and a unique identifier can both be read and checked against records in a database to verify that the personal identifier presented matches a record on the database. The card is not specific to any one digital entertainment work but can be used to purchase one or more of any works within the database. In other cases a prepaid card is used without any code or personal identifier to purchase goods on a retail basis. An example is the current prepaid card sold by Starbucks (trade-mark). The card is presented for each purchase and a revised balance computed and stored on the card.

### SUMMARY OF THE INVENTION

According to the invention there is provided a method of distributing digital entertainment works at least partly over a global computer network, which includes providing a card containing a code and information as to a digital entertainment work associated with each card, distributing the card to a purchaser, and providing a website having a transfer area, the website being accessible over the Internet by the purchaser utilizing a user computer. In response to the purchaser requesting access to a transfer area of the website and, in response to a direction, inputting the code and prompted information about the specific digital entertainment work, verifying an authenticity of the card. The purchaser is then provided access to the transfer area for the purpose of transferring the digital entertainment work. Finally the purchaser is permitted to transfer the digital entertainment work onto the user computer in response to a purchaser direction to do so.

The digital entertainment work may be selected from the group consisting of a song, a movie, a television and a concert show.

The transfer area permits transferring of the digital entertainment and is accessible only with the code and the information.

Should the transferring step fail, the purchaser is given a second opportunity to transfer the digital entertainment work within a predetermined time.

Advantageously, the card may contain information selected from the group consisting of artwork, images, photography, lyrics or biographical information so as to make the card a collectible.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a schematic diagram of the system used to carry out the method; and

FIG. 2 is a flow diagram of the method.

### DETAILED DESCRIPTION WITH REFERENCE TO THE DRAWINGS

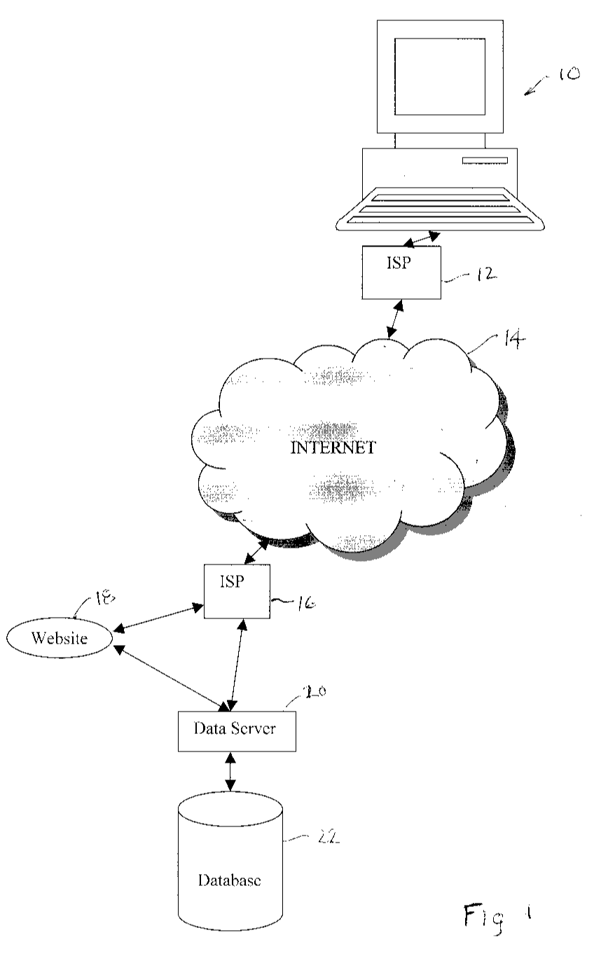

Referring to FIG. 1, a user computer 10 communicates through its ISP 12 to the Internet. A website 18 hosted by an ISP 16 receives the communications from the user computer 10 through its ISP 12 and a network such as the Internet 14. The website 18 contains a link that invites the user to transfer digital entertainment. If the link is clicked, the website 18 requests information as to the code of the prepaid card, whether the digital entertainment work is a song, a movie, a TV show, a book or a concert video, and information on the card as to the artist(s) singing the song, the principal actor/actress or title of the TV show or movie or other identifying indicia. Upon receipt of the information, the website communicates with a data server 20 which accesses a database 22 and verifies that the card is authentic. Once verified, the user 10 is informed that he can commence transferring the digital work corresponding to the card. In the event the transfer is unsuccessful due to such events as a service interruption, the user 19 is given a second opportunity to transfer the digital work. A user 10 has 24 hours after a first unsuccessful attempt to transfer to make a second attempt.

After a transferring is complete, a user 10 is sent back to the home page of the website and eventually leaves the website 18 altogether. An additional revenue source is obtained through advertising on the website 18 and on the card or on the packaging for the card or on inserts accompanying the card. The card also contains biographical information and pictures of the artist, author, starring actor, a list of movie content, and/or lyrics of the song. The cards may be purchased at retail outlets or vending machines.

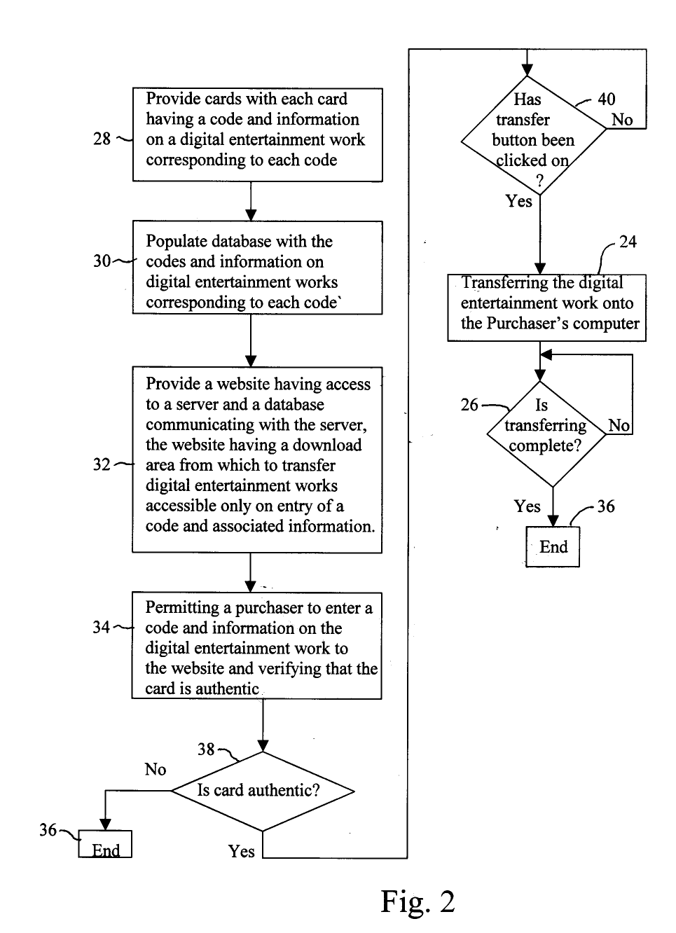

Referring to FIG. 2 the system includes fabricating cards at step 28 which contain a code number or on the packaging for the cards and inserts to accompany the cards in the packaging, information on the front as to the digital entertainment work, such as the name of the artist of a song and the lyrics and the title of the song. The card is given a unique design to make it attractive as a collectible. Cards are distributed to retail outlets and from vending machines where they are sold for the price of a single song plus the value of the card. The database 22 is populated at step 30 with the codes and some of the other information printed on the card for each of the plurality of cards. A website associated with the cards is provided and accessed at step 32 by the Purchaser of a card. A transfer link is clicked by the Purchaser on the website 38 signifying that the Purchaser wishes to transfer a digital entertainment work. In response, at step 34 the purchaser is invited to enter the code and information about the digital entertainment work that appears on the card. Once entered the data server 20 has a software program which accesses the database 22 to verify the accuracy of the data entered. If the data matches, then the card is verified as authentic at step 38 and then step 40 is carried out. If the card is determined not to be authentic then the program goes to step 36 where it is terminated. At step 40 if the Purchaser has clicked the transfer link, then transferring begins at step 24. If not then the system returns to the input of step 40. Once transferring onto the Purchaser's computer has been completed, then at step 26 the system goes to the end at step 36.

An advantageous feature of this system is that there is no financial transaction or requirement to ascertain a credit balance available on a card over the Internet. The only transaction that takes place over the Internet is the transferring of the digital entertainment work. Further there is no requirement for a card reader or other electromechanical device to read the card and update its information as only one prepaid transaction is involved.

It will be appreciated that the work required to protect against an unauthorized use of a prepaid card to obtain a single digital entertainment work is minimal, the combination of utilizing a code on the card that is different for each card and an item of information on that card which is unique to the card is enough to deter any unauthorized use. If a hacker does penetrate a code, he/she gains access to only a single song.

It will be appreciated that various modifications of the invention within the above teachings and purview of the appended claims are possible without departing from the spirit and intended scope of the invention.

1. A method of distributing digital entertainment works, comprising:
(a) providing a packaged card, the card or packaging containing a code and information as to a digital entertainment work associated with each said card;
(b) distributing said card to a purchaser;
(c) providing a website having a transfer area, said website being accessible over the Internet by said purchaser utilizing a user computer;
(d) in response to the purchaser requesting access to a transfer area of said website and, in response to a prompt, inputting the code and prompted information about the digital entertainment work, verifying an authenticity of said card;
(e) providing said purchaser access to said transfer area for the purpose of transferring said digital entertainment work; and
(f) transferring the specific digital entertainment work onto the user computer in response to a purchaser direction to do so.

2. The method according to claim 1, wherein the specific digital entertainment work is selected from the group consisting of a song, a movie, a book, a concert video, and a television show.

3. The method according to claim 1, wherein the digital entertainment work is a song and the card contains said code and one or more items selected from the group consisting of artwork, images, photography, lyrics or biographical information about an artist of the song.

4. The method according to claim 1, wherein said transfer area permits transferring of the digital entertainment, said transfer area being accessible only by inputting said code and said information.

5. The method according to claim 1, wherein said information is a title of said digital entertainment work.

6. The method according to claim 1, including allowing said purchaser a second opportunity to transfer said digital entertainment work within a predetermined time if said transferring step fails.

7. The method according to claim 1, wherein said information is selected from the group consisting of artwork, images photography, lyrics or biographical information so as to make the card a collectible.

8. A method of distributing digital entertainment works, comprising:
(a) providing a packaged card, the card or packaging containing a code and information as to a digital entertainment work associated with said card;
(b) distributing said card to a purchaser;
(c) providing a website having a transfer area, said website being accessible over the Internet by said purchaser utilizing a user computer;
(d) in response to the purchaser requesting access to a transfer area of said website, inputting prompted information about the digital entertainment work and the code;
(e) verifying an authenticity of said card using said prompted information provided by said purchaser;
(f) providing said purchaser access to said transfer area for the purpose of transferring said digital entertainment work, if the authenticity of said card is verified; and
(g) transferring the digital entertainment work onto the user computer in response to a purchaser direction to do so.

9. The method according to claim 8, wherein the digital entertainment work is selected from the group consisting of a song, a movie, a book, a concert video and a television show.

10. The method according to claim 8, including providing a purchaser a second opportunity to transfer within 24 hours of a first unsuccessful transferring attempt.

11. A method of distributing digital entertainment works, comprising:
(a) providing a plurality of cards, each of said cards containing a code and information as to a digital entertainment work associated with said each card;
(b) distributing said each card to a purchaser;
(c) populating a database with said code and said information for each of said plurality of cards;
(d) providing a website having a transfer area, said website being accessible over the Internet by said purchaser utilizing a user computer and said website having access to said database;
(e) verifying an authenticity of said each card in response to the purchaser requesting access to a transfer area of said website and, in response to a direction, inputting the code and prompted information as to the digital entertainment work,
(f) providing said purchaser access to said transfer area for the purpose of transferring said digital entertainment work; and transferring the digital entertainment work onto the user computer in response to a purchaser request.

12. The method according to claim 11, wherein said transfer area permits transferring of the digital entertainment work, said transfer area being accessible only with said code and said information.

13. The method according to claim 11, wherein if said transferring step fails, within a predetermined time allowing said purchaser a second opportunity to transfer said digital entertainment work.

14. A method of distributing digital entertainment works, comprising:
(a) providing a packaged poster, the poster or packaging containing a code and information as to a digital entertainment work associated with each said poster;
(b) distributing said poster to a purchaser;
(c) providing a website having a transfer area, said website being accessible over the Internet by said purchaser utilizing a user computer;
(d) in response to the purchaser requesting access to a transfer area of said website and, in response to a direction, inputting the code and prompted information about the digital entertainment work, verifying an authenticity of said poster;
(e) providing said purchaser access to said transfer area for the purpose of transferring said digital entertainment work; and
(d) transferring the specific digital entertainment work onto the user computer in response to a purchaser direction to do so.
